(19) United States
(12) Patent Application Publication
(10) Pub. No.: US 2016/0195491 A1
(43) Pub. Date: Jul. 7, 2016

(54) ION SELECTIVE ELECTRODE

(71) Applicant: K. Jagan M. RAO, Moorestown, NJ (US)

(72) Inventor: K. Jagan M. RAO, Moorestown, NJ (US)

(21) Appl. No.: 14/846,712

(22) Filed: Sep. 4, 2015

Related U.S. Application Data
(63) Continuation-in-part of application No. 13/727,486, filed on Dec. 26, 2012, now abandoned.

(51) Int. Cl. G01N 27/333; G01N 27/30

(52) U.S. Cl. CPC G01N 27/333; G01N 27/3335; G01N 27/301

(57) ABSTRACT

A five-part internal reference electrode, including a membrane formed in situ, which is useful in automated clinical chemistry analyzers, the method of forming a direct solid state connection to the membrane eliminating the need for the use of an internal reference electrode internal filling solution, and a ganged assembly of said internal reference electrodes with a grounding unit and an external reference electrode.

### RELATED APPLICATIONS

This application is a continuation-in-part of U.S. patent application Ser. No. 13/727,486, filed Dec. 26, 2012, entitled “Improved Ion Selective Electrode,” the entire contents of which are incorporated fully herein by reference.

### TECHNICAL FIELD

This invention relates to electrochemical analytical device and particularly to a new and improved ion-selective electrode structure used in the determination of ion (activities) concentrations, and methods for making such structures.

### BACKGROUND OF THE INVENTION

Ion-selective electrodes are used in clinical chemistry to measure concentration (activity) of ions (like sodium, potassium, chloride and calcium) in blood, serum, plasma cerebrospinal fluid and urine. These devices are used in automated and semi-automated instruments for direct measurements (undiluted samples) or indirect measurements (diluted) of samples. The use of such electrochemical devices for determining and measuring (activity) concentration of ions in solutions is now commonplace. In the usual form, such a device consists of a ion-selective electrode such as for instance a pH-selective glass electrode which is immersed into the solution whose ion (activity) concentration is to be measured. When the ion-selective electrode is immersed into the solution, a potential difference develops between the inner and outer layers of the membrane which is related to the ionic concentrations of the solution. Essentially, the ion-selective electrode and the solution constitute a half-cell and the developing potential is called the half-cell potential of the ion-selective electrode. To measure this half-cell potential, it is necessary to connect the ion-selective electrode and the solution to an electric measuring circuit. To do this, it is necessary to bring the solution into contact with another electrode, whereby the second electrode, also called reference electrode, should develop a constant half-cell potential which is essentially unaffected by concentration changes in the test solution. Usual practice employs a substantially reversible electrode system such as calomel electrode which is surrounded by an electrolyte such as, for instance, a saturated KCl solution, which in turn contacts the test solution. The junction between test solution and saturated KCl solution is called liquid junction. Generally one provides a constriction in the liquid path between two half cells which reduces the liquid flow between the half cells to a minimum, yet permits electrical conduction through the adjoining liquids.

Ion-selective electrodes obey the Nernst Equation. Any change in the activity of the measured species in solution causes a change in the measured potential which can be related to the (activity) concentration of the unknown specimen by proper calibration. Ion-selective electrodes are available for anions (e.g. F−, Cl−, Br−, etc) and cations (e.g. H+, Na+, K+ etc.) They are also available for some divalent ions like Ca++. Ion-selective electrodes are classified into four broad groups: . Glass electrodes, e.g. H+, Na+; Pressed pellet or single crystal electrodes, e.g. F−, Br−; Gas sensing electrodes e.g. Ammonia, CO2; and Liquid membrane electrodes, e.g. K+, Ca++, etc. Such electrodes were originally made by dissolving the active ingredient (e.g. for K+, Valinomycin) in an appropriate solvent and impregnating a filter paper with this solution. Ideally, the active ingredient is practically insoluble in water and the solvent selected also has minimum solubility in water. This type of electrode is clumsy to make and has a fairly short useful life. Some electrodes were made with a built-in reservoir of the “active solution”. These electrodes gave a somewhat longer life but were difficult to assemble and were not popular because of the obvious drawbacks.

The next development in liquid membrane electrodes was the making of a polymeric membrane. These were made by dissolving a polymer such as polyvinylchloride (PVC) in tetrahydrofuran (THF) and then adding the active ingredient such as Valinomycin to the mixture together with a plasticizer in this case, di(2-ethyl hexyl)sebacate which is a solvent for the active ingredient. After thoroughly mixing, the mixture is evaporated in a flat container to drive out the solvent THF. This leaves a film of PVC which can be easily peeled off from the container. Ideally this film has a thickness of 6-10 mils. Dip electrodes were made by “gluing” a small piece of this membrane to the end of an open tube and using Ag/AgCl wire with KCl filling as the internal reference electrode. This type of electrode works well, has extended life and was easy to use.

The membranes in film form were also made into flow-thru electrodes involving a fairly complicated electrode design. These flow-thru electrodes are difficult to assemble properly and, once assembled, the life of the electrode is very unpredictable. U.S. Pat. Nos. 4,233,136 and 4,314,895 (assigned to Nova Biomedical Corporation, referred to hereinafter as “Nova”) describe a “flow-through”, liquid membrane electrode and a method of making the electrode. The flow-through electrode comprises a tube in which a portion of the wall comprises a membrane containing a liquid phase ion exchange material for the electrode. The membrane is integrally sealed to the wall of the flow-through tube. The method of making the electrode comprising the steps of dissolving an organic plastic matrix material in a volatile solvent and then mixing a non-volatile solvent-plasticizer and an ion exchange material (in case of K+ it is a neutral carrier complex), which is soluble in the plasticizer, with the plastic material and the volatile solvent. The solution thus obtained is cast on a surface to form a membrane as the volatile solvent is evaporated. The membrane is attached to a tube of organic plastic material by contacting the tube with a volatile solvent common for the membrane and the tube and abutting the membrane material against the tube. As the solvent evaporates, the tube and membrane are integrally joined. In a particular embodiment, an opening is formed in the tube to receive the membrane. A mandrel is inserted within the tube and across the opening. The membrane is then formed on the mandrel contacting the tube edges at the opening and the volatile solvent in the membrane contacts the tube edges thereby resulting in the joinder of the membrane to the tube as the volatile solvent evaporates. In a particular embodiment of the above-described flow-through electrode for detecting potassium ions, the matrix material is polyvinylchloride, the ion-exchange material is valinomycin, the non-volatile solvent comprises 2-nitro-p-cymene and the volatile solvent is a tetrahydrofuran. The membrane thickness is preferably in the range of from 8-12 mils, the polyvinylchoride matrix material comprises from 8-26%, preferably from 12-20%, by weight of the membrane. The patentees report that an electrode assembly according to the invention supports and seals a liquid membrane integrally with the wall of the tube thereby permitting the construction of a linear flow-through liquid membrane electrode. The smooth linear flow path avoids turbulence and eddy currents as well as mechanical discontinuities which can trap portions of the liquid sample being tested and permits a more accurate, rapid and reliable response. The use of tubing allows a small diameter flow path minimizing the amount of sample required. The matrix support of the ion exchange material and the linear flow path eliminate the danger of rupturing the liquid membrane. The fabrication of the membrane to the flow-through tube is simple and convenient.

Good performance and long life of such ion-selective electrodes requires the proper plasticizer in the membrane in a fairly large quantity and, of course, a large amount of the active ingredient which is held in the membrane with the plasticizer. One of the problems associated with the flow-through electrodes described above is the limited surface area possible if the membrane is to be structurally stable. The membrane is relatively delicate compared to the tube wall. While the membrane is bonded to the tube wall, nevertheless, the size of the “interruption” in the tube wall described by the patentees must be limited to a small area into which the membrane is relatively self-supporting. If the active area of the membrane is too great, it will cease to be self-supporting and will collapse or, at the least, be subject to rupture or breaking with relatively little force. The limited size of the available active area, therefore, severely limits the amount of plasticizer that can be maintained in the membrane and, therefore, also the amount of dissolved active ingredient. As a result, many of these structurally stable electrodes of the above described type have a relatively short life under normal use conditions.

The next advance in this technology embodies an improved flow-through electrode. Rao, et al, in U.S. Pat. No. 5,013,421, the disclosure of which is incorporated herein by reference, they described a flow through type ion-selective electrode device which uses a micro-porous tubular material impregnated with a matrix of an organic plastic material containing a nonvolatile solvent plasticizer and an ion-active material dissolved in the plasticizer, the plasticizer not being solvent for the tubular material. The electrode assembly they disclosed involved a membrane material in which the membrane material communicates electrically directly through a metal conductor. It comprised a porous material in which the pores are impregnated with a membrane material. The membrane comprises a matrix of an organic plastic material containing an ion exchange material and a non-volatile plasticizer which is a solvent for the ion exchange materials but not for the material of the support tube. The resulting impregnated tube can be used in the same way that the membrane-containing tube of U.S. Pat. No. 4,314,895 is employed. However, Rao, et al, also contemplated a preferred and superior means for effecting electrode contact in which an electrode wire is placed in direct contact with the outer side of the impregnated pores of the membrane material and held in electrical contact in that position. The electrical wire is preferably wound around the impregnated tube, and additional membrane material is applied over the surface of the wire and tube to form a cohesive coating of the electrode material in electrical contact with the membrane material.

The membrane material can be any of the suitable membrane materials already known in the art. The membrane materials described in some detail in the aforementioned U.S. Pat. No. 4,233,136 and U.S. Pat. No. 4,314,895 are suitable for use herein with the proviso discussed above concerning the selection of a solvent plasticizer material for compatibility and non-solvency.

These flow-through electrodes are incorporated into a flow system using a peristaltic pump. Typically, as an example of use, an Ag/AgCl flow-through electrode with 0.1 M. KCl flowing through it can be used as the reference electrode. The sample and reference streams meet after passing through the respective electrodes and then the combined stream goes to waste. Liquid junction is made close to the two electrodes. Orion model 801 PH meter can be used to measure the potential readings in millivolts. Aqueous solutions of KCl can be used as the standards.

The electrode described in the above-identified patents gives stable potentials, gives extended linear range and performs well in measuring the desired ionic species in the samples. However, the material used for the micro-porous tube has very limited number of manufacturers and is quite expensive. In addition, the manufacturing of the electrodes includes several steps spread over a number of days and there is no known way to speed up the process. A lot of skilled manual labor was needed to make these electrodes. Further, before final assembly, the electrodes need about 90 days of curing at room temperature for good slopes, drift free operation and good usage life. This electrode required nine different custom-made parts which contributed to large inventory and cost problems. The finished electrode has fairly large internal volume so it was not suitable for direct (undiluted) sample measurements. All these add to the cost of the product.

U.S. Pat. No. 5,393,401 to Knoll et al (referred to hereinafter as Knoll) teaches a process for producing small, miniaturized chemical and biological sensor elements with ion-selective membranes. These are not, in the true sense, ion-selective electrodes. In the art they are known as VISFETs or vertical ion-selective field effect transistors. These are single use devices that cannot be used in flow-through configuration, even though sometimes treated as though they are related to flow-through electrodes. In fact, they are only “dip type” electrodes. Knoll teaches a conductive barrier membrane (interior-electrolyte layer 31) covering the ion-selective electrode and reference electrode (Noll's FIG. 7) but can be seen to be two separate layers. The bottom layer is the ion-selective membrane and the top layer is an electrolyte layer—two different formulation layers in contact with each other. Knoll teaches the use of a single crystal silicone substrate having a front and back side and having one of a (100) and a (110) orientation in its plane. To make the membrane stick to the “walls of the body cavity” he describes the use of elaborate anisotropic etching process using known lithographic and masking process to obtain depressions or holes in the silicone mono-crystal. Without this elaborate “etching” process the membrane will not stick to the cavity. Knoll describes the opening as tapering from front side to the back side in the form of a truncated pyramid. In this disclosure, the surfaces of the pyramidal depression are slanted at a substantial angle, and this slanting angle and etching of the slanting pyramidal opening “walls” is very critical for the membrane to stick to the surface of the silicone substrate. Further, the VISFET electrodes work only with single crystal silicone with special crystal orientation and etching process. They do not work with commonly available industrial plastic electrode bodies. The Knoll membranes are very thin, typically, 0.1 to 1 mm.

### SUMMARY OF THE INVENTION

The present invention comprises a five-part electrode device, counting the membrane formed in situ, which provides substantial improvements over the above noted inventions and yet retains all the desirable characteristics and improved performance needed for the device's use in automated clinical chemistry analyzers. It also provides a direct solid state connection to the membrane eliminating the need for the use of internal reference electrode with internal filling solutions. This flow-through electrode can be made in half a day while actually occupying only a few minutes of the manufacturer's time in the conduct of the manufacturing steps. This device uses substantially less active reagent than the older device there by minimizing the use of costly ion-selective reagents and contributing to less expensive product. The manufacturing process for the new device is suitable for semi-automatic operation there by contributing to further reduction of manufacturing costs and providing increased productivity. The new invention electrodes cure in substantially less time (about 15 days) compared to 90 days for the older electrodes. Thus there is no longer a need to make electrodes ninety or more days in advance; they can be made about 18 days before they are needed. This allows for reduced inventory and reduced overhead costs for the product. The new device “exposes” only a small portion of the membrane to the flow path compared to the full length of the membrane in the older design electrodes. Since a smaller portion is exposed compared to the total length of the membrane tube; this device gives substantially longer usage life of the electrode than the older design electrodes. Since it is a solid state electrode without any internal filling solutions, it gives more than two years of shelf life. This is very important for the distributor and the customer.

### DESCRIPTION OF THE DRAWINGS

FIG. 1(A), FIG. 1(B), FIG. 1(C), and FIG. 1(D) are, respectively, a perspective view of electrode body, 10; a perspective view of electrode front cover 20; a perspective view of electrode back cover 50 and electrical connector 31; and a perspective view of the electrical connector disconnected from the electrode back cover 50.

FIG. 2(A) and FIG. 2(B) are two separate views of the electrode body according to the invention.

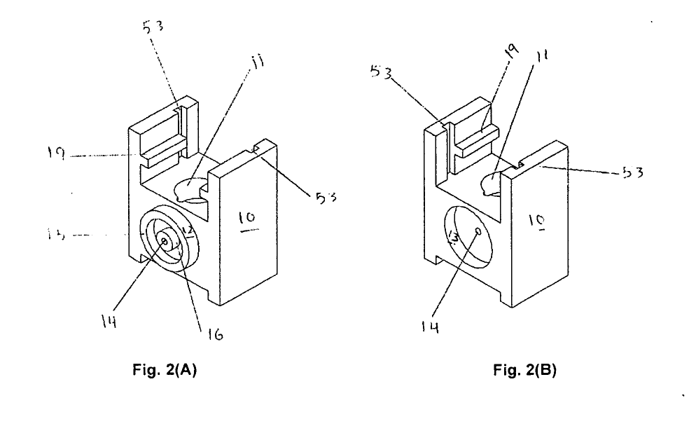

FIG. 3(A), FIG. 3(B) and FIG. 3(C) are three separate views of the electrode front cover.

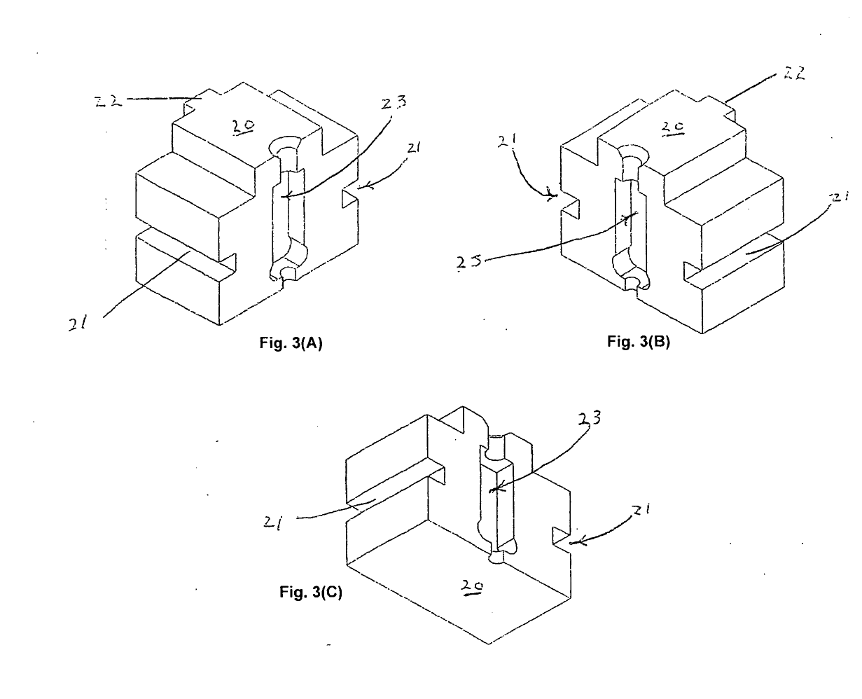

FIG. 4 is a top view of the electrode body of FIGS. 2(a) through 2(c) showing the details of the electrode-receiving cavity in the electrode body.

FIG. 5 is a view of the final electrode assembly

### DETAILED DESCRIPTION

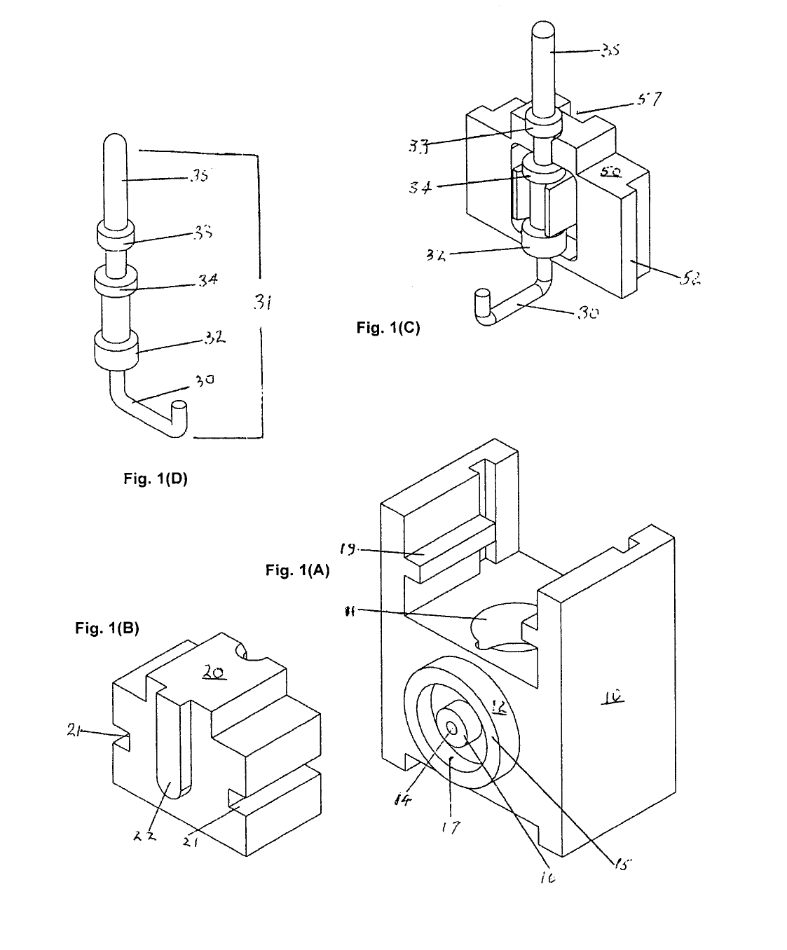

The present invention embodies a novel linear flow-through electrode As shown in the accompanying drawings, the electrode comprises an electrode body (10), an electrode front cover (20), Electrode back cover (50) and a silver wire internal reference electrode (30) having an electrical connector (31) to connect the electrode to a measuring instrument. The connector typically has a crimping ring (32) for attaching the connector to the silver wire electrode (30), and spacer bushings (33) and (34) for spacing and holding the silver wire electrode and connector assembly in the final flow-through electrode assembly. In FIG. 1, wire 35 will connect directly to the measuring instrument.

The electrode body has a deep cavity (11) and has one male (12) and one female (13) bushing on either side of the flow path (14) through the body of the electrode. The male bushing (12) has a deep groove (17) between the outer (15) and the inner (16) circles of the bushing. An “O” ring can be installed into this groove and this “O” ring provides a leak free connection of the electrode with the female (13) bushing of the next electrode or to the waste outlet, as the case may be.

The electrode front cover (20) has an indentation (21) in it. This slips onto part (19) of the electrode body and provides a tight fit of the front cover to the electrode body. This cover is glued to the electrode body with a proper adhesive.

The electrode back cover (50) has an indentation (53) on the back side top of the body. When using multiple, ganged electrodes, this indentation can receive the part (22) of other electrode front cover (20) and assures proper alignment of the electrodes on the system. This is important for a smooth linear flow through the electrodes.

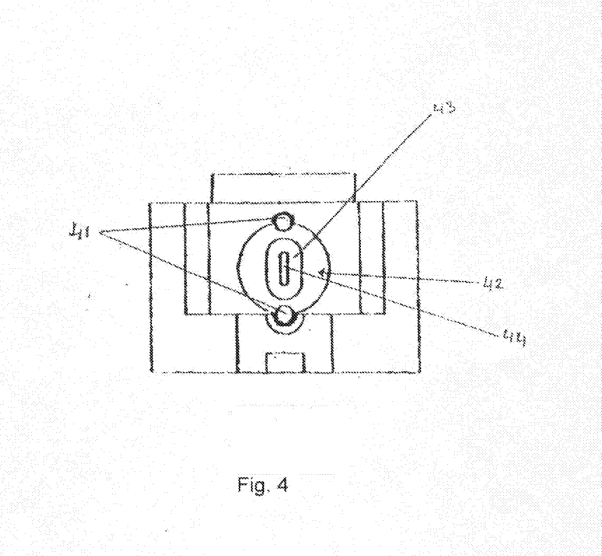

FIG. 4 shows the details of the cavity in the electrode body (10) viewed from the top. The drawing shows a lager upper cavity (42), the smaller lower cavity (43) and the opening (44) to the top of the flow path in the electrode body (10). The silver internal reference electrode fits in to the two grooves (41) on opposite ends of the larger cavity.

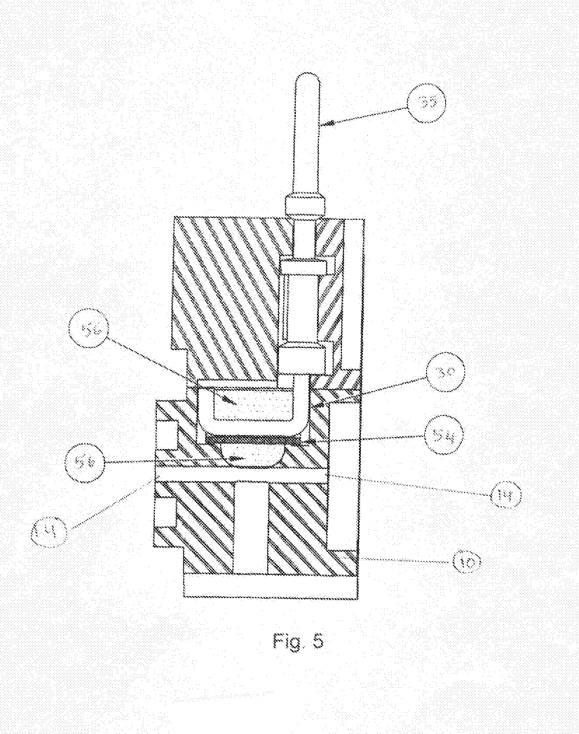

The silver wire electrode (30) is installed in the upper larger cavity (11) of the electrode body (10). The silver wire fits firmly in to the “grooves” (41) in the electrode upper cavity and the electrode connector (31) fits firmly in to the back cover “clip” (51). When the electrode body (10) and the back electrode cover (50), and the front electrode cover (20) are assembled to each other, indentations (23) and “clip” (51) match up to define a space in which the electrode-connector combination is held in operating position. A mandrel having an O.D. slightly less than the I.D. of the electrode flow path is inserted in to the flow path (14) of the electrode body. The mandrel prevents the active reagent of the electrode from leaking out when the electrode cavity is filled with the reagent. The electrode body has two cavities 42 and 43 (one below the other) as shown in FIG. 4. The silver wire with the electrode connector is installed in the top larger cavity of the body. The way it is designed, the bottom of the silver wire is kept slightly above or in contact with the “barrier membrane” (54) as shown in FIG. 5. The “barrier membrane” is positioned slightly above or on top of the smaller “tapered” bottom cavity of the electrode body. The depth of the smaller cavity and the distance from the bottom of the cavity opening (44) to the bottom of the silver wire controls the thickness of the ion-selective electrode membrane. The “barrier membrane” forms an integral part of the total membrane.

The thickness of the membrane can be varied by varying the length of the silver wire attached to the connector. An important factor in the present invention is that the in situ membrane as produced is 2 to 6 mm in thickness. The “barrier membrane” forms an integral part of the total membrane. The thickness of the membrane can be varied by varying the depth of the smaller cavity and varying the length of the silver wire attached to the electrode connector. The smaller tapered bottom cavity 43 connects to the top of the flow path through a small opening 44 in the bottom of the cavity as shown in FIG. 4. The size of the opening controls the exposure of the membrane to the sample flowing throughflow path of the electrode. The electrode back cover 50 has two projections (52) on both sides of back of the cover. A thin layer of proper adhesive is applied to these two projections and the cover is slid down in two indentations (53) of the electrode body. This keeps the electrode back cover glued in place to receive the silver wire with the connector. After inserting a mandrel in to the flow path of the electrode body, the electrode cavity is filled with an appropriate ion-selective electrode active reagent mixture. One such mixture comprises of a polymer such as polyvinylchloride (PVC) in tetrahydrofuran (THF) solvent to which has been added an active ingredient such as Valinomycin together with a plasticizer such as di(2-ethyl hexyl)sebacate which is a solvent for the active ingredient. The method of making the ion-selective electrode active reagent mixture comprises the steps of dissolving an organic plastic material in the volatile solvent and then mixing the non-volatile plasticizer and an ion exchange material (in the case of potassium it is Valinomycin), which is soluble in the plasticizer, with the plastic material and the volatile solvent. The reagent flows in to the lower tapered small cavity of the electrode and fills it. Enough reagent mixture is added to the cavity 11 to completely fill the smaller cavity and fill half of the larger cavity. After the first filling the electrode is allowed to “cure” for about an hour at room temperature. During this time, most of the tetrahydrofuran solvent evaporates away and the membrane shrinks considerably in to the cavity. After about one hour curing, the cavity is again filled with a few drops of the reagent mixture and allowed to cure again. Once the cured membrane completely covers the smaller tapered inner cavity to the top (this could take one or two fillings), a “barrier membrane” soaked or impregnated with the active reagent is installed above inner cavity membrane, the silver wire with the connector is then inserted in to electrode cavity and snapped in to place into clip 51 of the electrode back cover. After installing the soaked barrier membrane and the silver wire, the electrode cavity is filled to the top with the reagent mixture. Again it is allowed to cure for about an hour and filled again. This procedure of filling the cavity is repeated about three to five times (depending up on the type of electrode). After the final fill the electrodes are allowed to cure at room temperature for about 15 days.

In general, membranes made for the solid-state electrodes are soft and some electrode reagent formulations have a tendency to trap air bubbles within the membrane matrix. Air bubbles, if present in the membrane could contribute to membrane failure by creating a shorting path between the sample and the internal reference electrode. This is not desirable. For such electrode formulations one way of overcoming the problem is by inserting a “conductive barrier” between the sample flow-path and the internal electrode which would allow ionic mobility within the membrane but prevent the shorting path between the internal reference electrode and the sample. This type of barrier membrane (54) is shown in FIG. 5.

The “barrier membrane” (54) shown in FIG. 5 helps to give some “rigidity” to the electrode membrane structure (which is generally soft) and also, helps in preventing the micro air bubbles (if any formed during curing) from shorting the membrane. The barrier membrane can be a thin filter paper type material cut in to round disk. With this invention electrode design, a disk of membrane cut with a paper-hole puncher fits perfectly well in to the electrode cavity hole. The disk is first soaked or impregnated with the active reagent mixture and then installed in to electrode cavity above the inner cavity. Once cured, the disk becomes an integral part of the total membrane. The silver wire with the connector is above the “barrier membrane”. The silver wire could be in contact or slightly above the “barrier membrane” as the case may be. The requirement for the barrier membrane material is that it is thin (like regular paper), is not soluble or reacts with any of the solvents, plasticizers or active ingredients used in making the membranes. It should also hold its shape when the membrane is cured.

After about 15 days of curing, the membrane shrinks in the cavity and gives a firm membrane (56). After the curing process is completed, the mandrel is pulled out. The mandrel comes out smoothly and formation of the membrane in the opening above the flow path at the bottom of the smaller tapered cavity could clearly be seen. The membrane formed in the two cavities covers the silver wire and the silver wire acts as the internal reference electrode there by providing solid-state connection to the electrode membrane. This avoids the use of clumsy silver/silver chloride internal reference electrode with associated liquid filling solutions. The front electrode cover is then installed to cover the electrode cavity and hold the electrode connector attached to the silver wire firmly in place.

As noted above, the flow-through electrode assembly of the present invention typically has a plastic housing with a cylindrical tubular passage of liquid sample through said assembly and a membrane material matrix comprising an organic plastic material containing non-volatile solvent plasticizer and an ion-active material dissolved in said solvent plasticizer, the plasticizer being essentially non-reactive with and non-solvent for the said passage material and the plastic housing. The plastic housing comprises generally a cylindrical tube wall defining a cylindrical liquid sample flow path through said electrode.

The membrane is formed in a cavity in the said plastic housing and the membrane communicates with the sample stream flowing through the said sample passage way by means of narrow opening in the side of the cylindrical passage, typically a length-wise opening of 1 to 5 mm and side-ways opening of 1 to 2 mm. It extends therethrough into direct contact with a reservoir of a solution of said plasticizer and ion active material in the polyvinyl chloride membrane matrix.

The membrane formed in the said housing cavity encompasses and communicates directly with a substantial portion of a metallic internal reference electrode wire which portion is surrounded by the said membrane material. A well and/or reservoir is filled with the organic plastic material containing a solution of non-volatile plasticizer and the ion-active material in PVC matrix. The plasticizer must serve as a a solvent for said ion-active material, but should not be a solvent for the material of the passage wall. These various inner parts must provide a direct electrode connection through a metallic conductor and the membrane material in the said cavity such that they, together, become the internal reference electrode without the use of any further electrolyte fillings, solutions or gels. The membrane thickness from internal reference electrode contact point to the sample contact point should be from between 1 to 6 mm.

A matrix material for a flow-through electrode assembly specifically adapted for the analysis of potassium ion may comprise polyvinyl chloride, valinomycin as the ion-active material, and dioctylsebacate as the plasticizer. Utilizing the right mixtures of materials with the in situ formation of the membrane, the present invention is able to produce a membrane containing 4% to 7.5% PVC as the matrix material, as a result of which the present invention is able to avoid the fragility in the membrane such as is encountered with the prior art. A flow-through electrode assembly may also advantageously utilize a membrane matrix material prepared from a mixture comprising approximately 40 mg. of valinomycin as the ion-active material, 4.5 gm. of dioctylsebacate, 7.3 gm. of 6% polyvinyl chloride in tetrahydrofuran, and 4 gm. of tetrahydrofuran.

A flow-through electrode assembly specifically adapted for the analysis of carbonate ion may utilize a membrane matrix material prepared from a solution comprising p-Decyl-alpha-alpha-alpha-trifluoroacetophenone in the range of about 0.4 to 0.8 gm.; tetraoctyl ammonium bromide in the range of about 0.2 to 0.4 gm.; di-(2-ethylhexyl) adipate in the range of about 2.5 to 4.0 gm.; about 6% polyvinyl chloride (high molecular weight) in Tetrahydrofuran(w/v) in the range of about 4.0 to 6.0 gm.

A particular advantage of the improved ion-selective electrodes of the present invention of the ability to select a plurality of such electrodes but of differing ion sensitivity and gang them serially such that there is only a single sample passage way thereby permitting multiple analyses with only a single, very small sample, and obvious advantage both financially and in the use of time. In such case, a suitable reference electrode is a sodium glass electrode with solid-state internal reference electrode. A ground electrode made of a stainless steel tube can be utilized to eliminates the electronic “noise” from the potential measurements. The only thing necessary for such ganging is that the ground electrode and the external reference electrode be made structurally compatible with the ion selective electrodes such that the sample being analyzed be ultimately able to pass serially through them at the conclusion of the serial analysis of the ions.

It should also be noted that the process utilized for the manufacturer of the improved ion-selective electrodes is unique, in and of itself. The importance of the in situ formation of the gel matrix around the silver wire cannot be underestimated. Accordingly, this process can be generally described as follows:

### Potassium Electrode Reagent Formulation

1 Tare the formulation container on an analytical balance.
2 Add the formulation quantities of the materials—in the sequence noted below.

Material
Valinomycin 100±5 mg.
Di(2-EthylHexyl) Sebacate 8.4±0.2 g.
Tetrahydrofuran (THF) 3.0±0.1 g.
6% PVC in THF (stock) 9.0±0.2 g.
   3 Stopper the formulation container and place on a Gyratory shaker and shake it slowly until a homogenous solution is obtained.
   4 Remove the formulation container from the shaker and let it stand for 15 minutes to dissipate the trapped air bubbles from the solution.
   This solution could now be used to make the Potassium electrodes.
   Note: This Formulation can be made in up to 10× times by simply increasing the material quantities making sure, exactly same proportions of each material is used to make the final reagent.

The procedure given below describes the Standard Operating Procedure (SOP) for making the Potassium electrode:

Materials Needed:

Potassium electrode active reagent mixture.

Electrode body, back insert and cover.

Electrode electrical connector.

Silver wire internal electrode.

Micro-pipette with disposable tips.

Stainless Steel mandrels (0.038″ O.D.).

Isopropyl alcohol.

Teflon Premium tape membranes.

Flat tipped tweezers.

Crimp tool.

Operating fume Hood.

Instant adhesive glue bottle with a brush.

Procedure Details:

Apply a thin coating of instant adhesive glue with a brush to the side of the electrode back cover and insert it in to the back grooves of the electrode body. The will glue the back cover to the electrode body. This will dry quickly in few minutes. Repeat the above procedure for all the electrodes being made in this lot. Clean all the mandrels with isopropyl alcohol. Allow them to “dry” at room temperature. Insert the cleaned mandrel in to the electrode flow path. The mandrel fits “snugly” in to the flow path and prevents any leakage of the reagent when the electrode cavity is filled with the reagent. Repeat the step D for all the electrode bodies to be made in this lot. Gently mix the Potassium electrode active reagent on a Gyratory shaker to get a uniform mixture. Allow it to stand for few minutes to eliminate any air bubbles trapped in the reagent to escape. Note: The reagent is fairly viscous. Using a syringe with flat stainless steel needle dispense a small amount of the reagent in to the cavity of the electrode. Dispense on to side of the cavity so as to allow the air to escape out and reagent to fill the lower bottom cavity without trapping any air bubbles in it. The reagent level should be approximately 2 mm up into the larger outer cavity.

This electrode design is applicable to all types of ion-selective electrodes which are generally made with PVC membranes. This approach can also be used with other types of polymers like poly urethane, carboxylated PVC, silicone rubber based membranes, just to mention a few. The technology can be used to make electrodes for potassium, a monovalent cation, and for carbonate, a divalent anion, as well as for calcium, chloride, lithium, magnesium, and similar ions. Novelty is not claimed in the choice of specific matrix materials used for the membrane described herein, but is directed primarily to the structures involving direct electrode contact with the membrane material. Similarly, silver wire has been used for illustration but other metals of similar characteristics, e.g., gold and copper, may also be utilized. Other embodiments of this invention will occur to those skilled in the art when viewing the disclosure and appended drawings. Basic advantages of the present invention include the provision of a structurally stable membrane of much smaller surface area which allows the use of very small sample volumes with the electrodes so made.

What is claimed is:

1. A five-part unitary ion-selective electrode for use in clinical chemistry to measure concentration (activity) of ions, including sodium, potassium, lithium, chloride, and calcium, in blood, serum, plasma, cerebrospinal fluid, urine, fertilizer, and industrial fluids, comprising in combination:
an electrode body (10);
an electrode front cover (20);
electrode back cover (50);
a conductive metal wire internal reference electrode (30) having an electrical connector (31) adapted to connect the electrode to a measuring instrument; and
an ion-selective electrode membrane (56);
said electrode body (10) having an upper, large cavity (42) and a lower, smaller cavity (43) which together comprise deep cavity (11), and a flow path (14) adapted to receive a removable mandrel for closing off the discharge of fluid during filling of the cavities, said metal wire internal reference electrode(30) positioned with the metal wire extending into said larger cavity (42) of said electrode body (10), said electrode front cover (20) and said electrode back cover (50) affixed to said electrode body (10) to hold said reference electrode (30) and its electrical connector (31) in operating position, and said ion-selective electrode membrane (56) having been formed in situ in said deep cavity (11) having a thickness of 2 to 6 mm, to fill said cavity and electrically interface with and surround the otherwise exposed surface of the silver wire of said reference electrode (30).

2. An ion-selective electrode in accordance with claim 1 additionally having a conductive barrier membrane (54) positioned in the flow path of samples in said ion-selective electrode and said internal reference electrode (30).

3. In the production of a linear flow-through ion selective electrode, the improvement which comprises forming in situ the ion-selective membrane containing 4% to 7.5% of polyvinylchloride in the final membrane mass, and having a thickness of 2 to 6 mm, and positioned in surrounding, active relation to the silver wire of the reference electrode.

4. a linear flow-through ion selective electrode assembly comprising a plurality of internal reference electrodes adapted for analysis of different ions as described in claim 1 are ganged serially with each other and a a grounding unit, and an external reference electrode, serially with their sample flow paths aligned to provide a single flow path through said assembly.
